(19) United States
(12) Patent Application Publication
(10) Pub. No.: US 2014/0240810 A1
(43) Pub. Date: Aug. 28, 2014

(54) MEMS Drive and Beam-Steering Apparatus

(71) Applicant: ISC8 Inc., Costa Mesa, CA (US)

(72) Inventor: Itzhak Sapir, Irvine, CA (US)

(21) Appl. No.: 14/068,714

(22) Filed: Oct. 31, 2013

Related U.S. Application Data
(60) Provisional application No. 61/721,868, filed on Nov. 2, 2012.

(51) Int. Cl. G02B 26/08; G02B 26/10; H02N 2/04

(52) U.S. Cl. CPC G02B 26/0833; H02N 2/043; G02B 26/0858; G02B 26/085; G02B 26/10
USPC 359/221.2; 310/328; 359/224.1

(57) ABSTRACT

A drive apparatus and a beam-steering apparatus fabricated from a MEMS process. The apparatus has a first layer, a second layer and a plurality of fluid-filled volumes defined there between. A plurality of flexible structures such as bellows structures are defined on the first layer and are configured whereby a predetermined pressure in each of the volumes results in a predetermined displacement of the flexible structures. Pressurization means selectively changes the pressures in each of the volumes to define the predetermined displacement of the flexible structures. An electromagnetically reflective or mirror element and a plurality of drive beams are affixed to the reflective element and to one of the plurality of flexible structures whereby selected pressurization of the fluid in the volumes causes a predetermined displacement of the flexible structure to displace the reflective element about the plane of its surface.

### CROSS-REFERENCE TO RELATED APPLICATIONS

This application claims the benefit of U.S. Provisional Patent Application No. 61/721,868, filed on Nov. 2, 2012, entitled “MEMS Laser Steering Device”, pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of laser scanning systems. More specifically, the invention relates to a MEMS-based laser scanning apparatus used to scan an incident Laser beam across a scene of interest in cooperation with system optics for use in, for instance, a light detection and ranging detector or LIDAR system.

2. Description of the Related Art

Prior art LIDAR laser scanners incorporating laser transmitters that are angularly disposed to a reflective scanner surface typically use a rotating assembly of flat mirrors or an oscillating mirror to achieve a desired scan angle.

The prior art laser scanning devices described above have inherent size, weight and power (SWaP) limitations owing to the mechanical concepts behind them. To date, solutions to various deficiencies in the prior art have primarily involved design optimization for each approach but with no material conceptual breakthrough occurring.

The above referenced prior art laser scanning systems generally require a laser steering mechanism that directs the beam in a continuous scan pattern or that can point it in a random direction. Mechanical beam-steering devices using electric or hydraulic actuators to vary the X-Y plane of a scanning mirror are commonly used for this purpose but are usually large and heavy and high in power consumption. In beam-scanning applications that require low SWaP, a mechanical beam-steering device may not be the best fit; particularly in view of the tact a mechanical scanning device reduces the overall reliability of the LIDAR system.

For line scanning of a beam, a galvo-motor and mirror assembly, such as are available from Cambridge Technology, are used in certain prior art applications. For area scanning of a beam, there are existing electrical/hydraulic beam-steering devices such as assemblies fabricated by Ziva Corporation. Both of these are undesirably of a macro-scale with high SWaP.

A micro-scale beam-steering device is available, such as Texas Instruments' DLP (digital light processor) chip, but cannot function as a random steering device as it is a two-state mirror switch and thus cannot address all beam-scanning applications.

The disclosed MEMS laser scanning apparatus herein provides a micro-scale, random laser beam-steering device with low SWaP and has the high reliability of a MEMS (Micro Electro Mechanical System) device.

No such solution for laser beam scanning is known to be used in the prior art.

### BRIEF SUMMARY OF THE INVENTION

A MEMS vertical drive apparatus and beam-steering apparatus such as for use in a LIDAR laser seamier are disclosed.

The apparatus of the invention is provided with a first layer, a second layer and one or a plurality of fluid-filled volumes defined there between.

One or a plurality of vertically flexible structures such as a bellows structure are denned on the first layer and configured whereby a predetermined pressure in each of the volumes results in a predetermined vertical displacement of the respective flexible structures.

Pressurization means is provided for selectively changing the pressures in each of the volumes to define the predetermined vertical displacement of the flexible structures.

An electromagnetically reflective or mirror element and a plurality of drive beams are affixed to the base of the reflective element and to respective ones of a plurality of flexible structures whereby a selected pressurization of the fluid in the volumes results in a predetermined vertical displacement of the flexible structures to displace the reflective element about its X-Y plane.

in a first aspect of the invention, a drive apparatus fabricated from a MEMS process is provided comprising a first layer, a second layer and a fluid-filled volume defined between the first layer and the second layer. A flexible structure is defined on the first layer and is configured whereby a predetermined pressure in the fluid-filled volume results in a predetermined displacement of the flexible structure. Pressurization means is provided for selectively changing the pressure in the fluid-filled volume to define the predetermined displacement.

In a second aspect of the drive apparatus of the invention, the pressurization means is comprised of a piezoelectric element configured to selectively deflect in and out of a plane.

In a third aspect of the drive apparatus of the invention, the pressurization means is comprised of a magnetic actuator element, such as a MEMS-fabricated magnetic actuator element configured to selectively deflect in and out of a plane and may be provided to cooperate with one or more flexure structures. As is known, a MEMS magnetic actuator is a device that uses MEMS process technology to convert an electrical signal (current) into a mechanical output (displacement) by employing the well-known Lorentz Force Equation or the theory of Magnetism.

By way of example and not by limitation, U.S. Pub. No. US2011/0181885, published Jul. 28, 2011 and entitled “Large-Displacement Micro-Lamellar Grating Interferometer” to Hsu, et al., the entirety of which is incorporated herein by reference, discloses a MEMS magnetic actuator structure suitable for use with the instant invention.

In a fourth aspect of the invention, a beam-steering apparatus fabricated from a MEMS process is provided comprising a first layer, a second layer and a plurality of fluid-filled volumes defined between the first layer and the second layer. A plurality of flexible structures is defined on the first layer and are configured whereby a predetermined pressure in each of the volumes results in a predetermined displacement of the respective flexible structures. Pressurization means is provided for selectively changing the pressures in each of the respective volumes to define the predetermined displacements. The fourth aspect of the invention may further comprise an electromagnetically reflective element and a plurality of drive beams, each having a first terminal end affixed to a surface of the reflective element and having a second terminal end affixed to one of the plurality flexible structures.

In a fifth aspect of the invention, the beam-steering apparatus of the invention is comprised of a piezoelectric element that is configured to selectively deflect in and out of a plane.

In a sixth aspect of the invention, the beam-steering apparatus of the invention is comprised of a magnetic actuator element that is configured to selectively deflect in and out of a plane.

In a seventh aspect of the invention, the beam-steering apparatus of the invention further comprises a support element affixed to the reflective element and to the first layer.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a cross-sectional view of certain of the major elements of the vertical displacement apparatus of the invention.

FIG. 2 depicts a side view of certain of the major elements of the vertical displacement apparatus of FIG. 1 of the invention illustrating a positive and negative vertical deflection of the pressurization means and of the flexible structure of the invention.

FIG. 3A illustrates a perspective view from above of the beam-steering apparatus of the invention with the reflective element and internal fluid-filled volumes shown in broken lines.

FIG. 3B is a detailed view of a section taken along 3B-3B of FIG. 3A.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

Turning now to the figures, wherein like references define like elements among the several views, Applicants disclose a MEMS-based vertical displacement and beam-steering or laser scanning apparatus for use in, for instance, a LIDAR imaging system for scanning a scene of interest with a laser beam and detecting the time-of-flight of the return echo of the transmitted beam in order to create a three-dimensional image of the scene.

The invention is preferably a MEMS (micro-electro mechanical system) device fabricated from well-characterized MEMS semiconductor processes and fabricated by etching silicon wafers using processes similar to those used in microelectronics fabrication.

The device in its various embodiments may take advantage of piezo-hydraulic or magnetic coil-hydraulic actuation to generate scanner movement for the laser beam steering mirror.

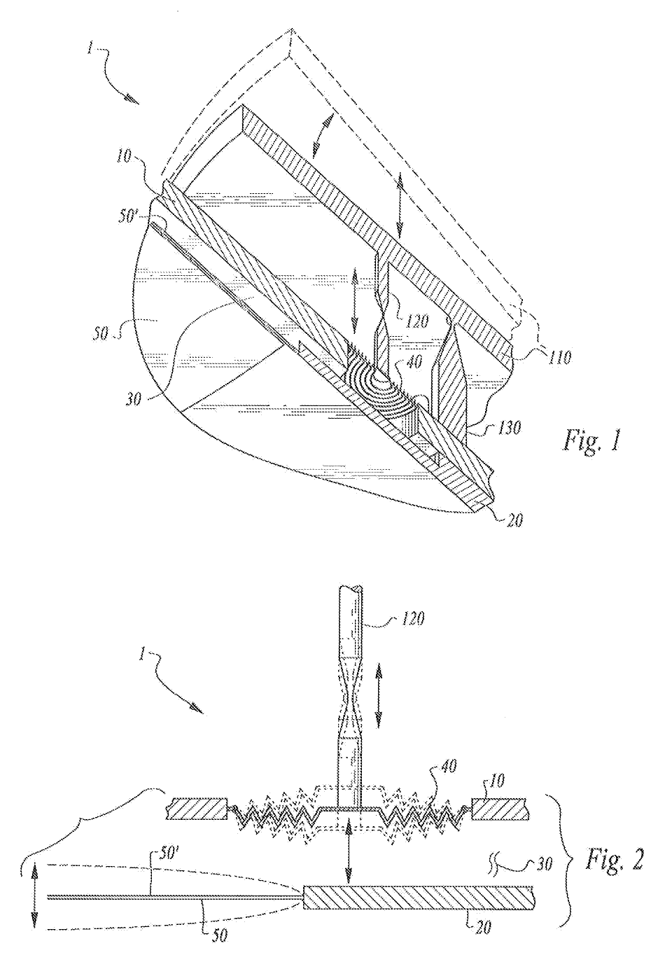

Turning to FIGS. 1 and 2, vertical drive element 1 is comprised of a first layer 10, a second layer 20 and a fluid-filled volume 30 defined between the first layer 10 and the second layer 20.

A flexible structure 40 such as a vertically flexible “bellows-type” structure is defined on the first layer 10 and is configured whereby a predetermined fluid pressure in fluid-filled volume 30 results in a predetermined displacement of flexible structure 40. The predetermined displacement may be a positive or negative vertical, horizontal or angular displacement with respect to the plane and surface of first layer 10 and the illustrated embodiment depicts a vertical displacement of flexible structure 40.

A pressurization means 50 is provided, preferably defined on or within the thickness of first layer 10 or second layer 20 or both, and is configured for selectively deflecting in and out of the plane of pressurization means 50, thereby introducing a force on fluid-filled volume 30 and thus changing the fluid pressure in the form of a positive or negative pressure in fluid-filled volume 30 to effect a predetermined vertical displacement of flexible structure 40.

In the preferred embodiment, the predetermined force is introduced on the fluid in fluid-filled volume 30 by a predetermined in-plane or out-of-plane deflection of the surface area of pressurization means 50, such as a selective concave or convex deflection of the planar pressurization means 50 that is disposed on or in first layer 10 and which deflection force is in communication with the fluid in the fluid-filled volume 30. Pressurization means 50 may be, by example and not by limitation, in the form of a piezoelectric disk of stack of disks, or a magnetic actuator element, being driven by an electronic control signal from an electronic control circuit (not shown).

Pressurization means 50 is configured to selectively deflect in or out of a plane responsive to and proportional to an electronic control signal.

In the piezoelectric pressurization means 50 form of actuation, a piezoelectric disk or stack of disks comprising a piezoelectric material may be deposited or otherwise disposed upon the outer surface, such as a floor or base, of a cylindrical volume defined in a base silicon wafer.

The piezo disk is preferably comprised of two piezo layers that may be selectively electrically energized using opposing polarity voltages to induce an expansion and contraction at the same time that is responsive to an electronic control signal. The result of energizing the two piezo layers with the electronic control signal is the bending in and out of plane of the disks in like manner to a drumhead driven in and out of its surface plane.

The floor or base of the cylindrical volume in the base wafer may be comprised of a thin silicon membrane 50′ portion that is bendable or deformable in and out of its plane as a result of the piezo layer deflection.

The base water may be bonded to a cap wafer comprising a flexible structure 40 such as a flexible, ribbed bellows structure defined therein.

A sealed volume is thus defined between the two bonded wafers by the above cylindrical volume in the base wafer. The cylindrical volume is filled with a fluid to define fluid-filled volume 30.

When energized, the piezo disk of pressurization means 50 deforms and bends the silicon membrane 50′ to increase or decrease the hydraulic pressure within fluid-filled volume 30. The changing hydraulic pressure in volume 30 creates opposing “push/pull” fluid forces on flexible structure 40. Flexible structure 40, in turn, moves in and out perpendicular to the first wafer plane to define a vertical displacement distance that is proportional to the fluid pressure introduced into fluid-filled volume 30.

The area ratio between membrane 50′ and flexible structure 40 determines the vertical displacement of flexible structure 40 as well as its vertical driving force.

In an alternative embodiment, pressurization means 50 may comprise a magnetic actuator element such as a MEMS-fabricated magnetic actuator element.

In this embodiment, an actuator may formed by a providing set of conductors or coils mounted on the exterior surface of silicon membrane 50′ above. The coils may be configured to cooperate with a permanent magnet that is positioned on or proximal silicon membrane 50′.

When current is passed through the conductors or coils, the interaction between the current and the magnetic flux produces an electromotive force. The conventional expression for the magnetic force is expressed as:

Fm=I×B

Where Fm is the magnetic force; I is the current and B is the magnetic flux. All three parameters are vectors and the “×” is the cross-product operator. By designing the coil geometry and aligning the permanent magnet, a net force is generated. The magnitude of the force, hence displacement, can be controlled by modulating the current flow, preferably using suitable feedback/control circuitry.

Magnetic actuator position feedback can be obtained in several ways including capacitive sensing or inductive sensing from the coils.

Desirably, very high forces can be generated with the use of a MEMS magnetic actuator (sub-Newtons).

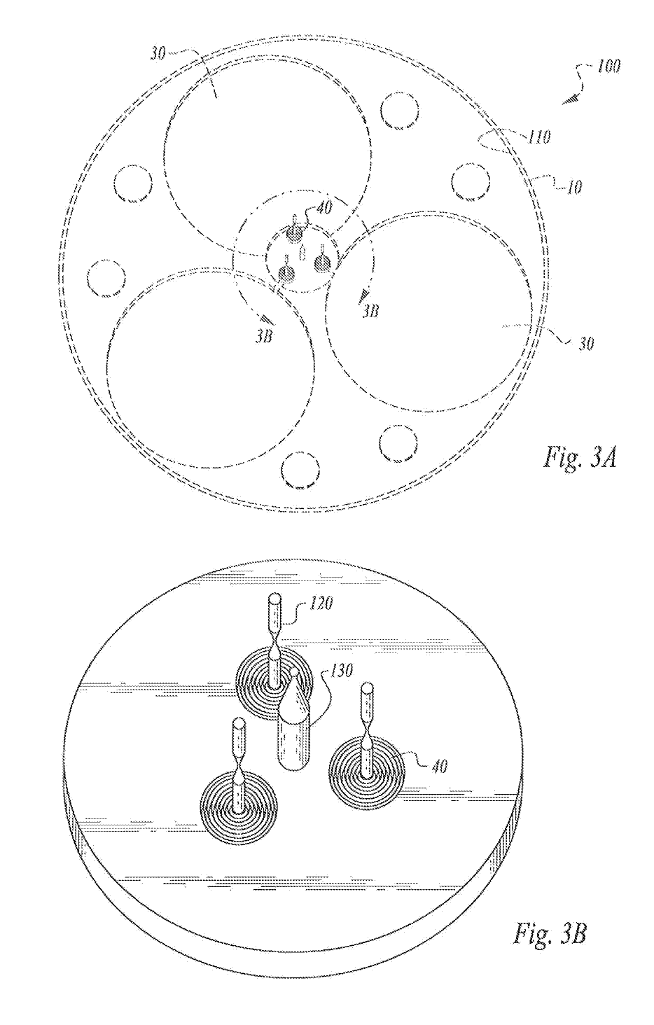

Turning now further to FIGS. 3A and 3B, a beam-steering apparatus 100 may be implemented using the vertical displacement apparatus 1 of the invention.

Beam-steering apparatus 100 may comprise an electromagnetically reflective element 110 such as a mirror element is affixed to first layer 10 by one or more drive beams 120.

In the illustrated preferred embodiment of FIG. 3A, mirror element 110 is affixed and driven by three drive beams 120 but the use of any number of drive beams is contemplated as within the scope of the invention.

A stationary anchor or support beam 130 is provided with a first terminal end affixed to the base surface of mirror element 110 and a second terminal end affixed to first layer 10. Support beam 130 defines the axis about which the X-Y plane of mirror element 110 is displaced.

Support beam 130 and drive beams 120 are preferably fabricated from etched silicon or other material having suitable material properties to permit continuous bending or deforming in the tapered “neck” areas of the beams as illustrated in FIGS. 3A and 3B.

The illustrated beam-steering apparatus 100 of the invention is preferably comprised of three separate and independently-controlled pairs of pressurization means 60/flexible structures 40.

Since reflective element 110 is anchored approximately in the center to a stationary point by means of support beam 130, beam-steering apparatus 100 effectively functions as an X-Y gimbal stage. Thus reflective element 110 is selectively “tilt-able” (i.e., it may be selectively angularly disposed or oriented relative to the plane of the first and second layers 10 and 20) at different angles to achieve different beam steering directions.

The electronic control of pressurization means 50 may thus be used to selectively and independently drive or vertically displace drive beams 120 to achieve a pre-determined scan pattern of reflective element 110 or to direct a scan in any random direction within the coverage cone of apparatus 100.

Apparatus 100 of the invention achieves low power consumption and when energized with a constant voltage (i.e., when pointing continuously to one direction), the piezo-actuation embodiment consumes practically zero power, thus providing a very low SWaP laser scanner mechanism for use in a wide number of applications.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions how or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A drive apparatus fabricated from a MEMS process comprising:
a first layer, a second layer and a fluid-filled volume defined between the first layer and the second layer,
a flexible structure defined on the first layer that is configured whereby a predetermined pressure in the fluid-filled volume results in a predetermined displacement of the flexible structure, and,
pressurization means for selectively changing the pressure in the fluid-filled volume to define the predetermined displacement.

2. The apparatus of claim 1 wherein the pressurization means is comprised of a piezoelectric element that is configured to selectively deflect in and out of a plane.

3. The apparatus of claim 1 wherein the pressurization means is comprised of a magnetic actuator element configured to selectively deflect in and out of a plane.

4. A beam-steering apparatus fabricated from a MEMS process comprising:
a first layer, a second layer and a plurality of fund-filled volumes defined between the first layer and the second layer,
a plurality of flexible structures defined on the first layer that are configured whereby a predetermined pressure in each of the volumes results in a predetermined displacement of the flexible structures,
pressurization means for selectively changing the pressures in each of the volumes to define the predetermined displacements,
an electromagnetically reflective element, and,
a plurality of drive beams each having a first terminal end affixed to a surface of the reflective element and having a second terminal end affixed to one of the plurality of flexible structures.

5. The apparatus of claim 4 wherein the pressurization means is comprised of a piezoelectric element configured to selectively deflect in and out of a plane.

6. The apparatus of claim 4 wherein the pressurization means is comprised of a magnetic actuator element configured to selectively deflect in and out of a plane.

7. The apparatus of claim 4 further comprising a support beam affixed to the reflective element and to the first layer.
